(19) United States
(12) Patent Application Publication
(10) Pub. No.: US 2009/0229496 A1
(43) Pub. Date: Sep. 17, 2009

(54) Methods for Forming Concrete Surfaces and Products Relating Thereto

(76) Inventors: Michael Eastergard, Evans, GA (US); David Rainess, Moresville, NC (US)

Correspondence Address: DORITY & MANNING, P.A., POST OFFICE BOX 1449, GREENVILLE, SC, 29602-1449, US

(21) Appl. No.: 12/046,949

(22) Filed: Mar. 12, 2008

(51) Int. Cl. C04B 40/00

(52) U.S. Cl. 106/823; 264/35

(57) ABSTRACT

In accordance with one embodiment of the present disclosure, a method for making a concrete product is described. The method includes positioning a base material and one or more forms together such that the base material and the one or more forms define a volume. The base material and the one or more forms comprise polyester, polyvinyl chloride, polyurethane, polypropylene, polyethylene terephthalate or combinations thereof. The method further includes adding concrete in the volume defined by the base material and the one or more forms and allowing the concrete to dry to a sufficient hardness.

### BACKGROUND

Concrete is a very versatile material and, as such, it is being utilized with greater frequency for making countertops and other surfaces. Shapes of concrete surfaces are limited only by imagination and the use of color pigments in combination with cement and other aggregates provides a virtually limitless spectrum of colors and textures that are available for such concrete surfaces. Furthermore, designers have utilized various techniques to add interest to concrete surfaces such as inlaid materials and the like.

Nonetheless, concrete surfaces are still a challenge to produce. For instance, wood forms are often utilized to shape and form concrete surfaces. Creating the forms needed to produce creative shapes and smooth finishes for concrete surfaces can require sophisticated carpentry skills that are beyond the expertise of many do-it-yourself individuals, if not experienced contractors. Additionally, current methods of producing concrete surfaces are labor intensive, time consuming, and require expensive materials that are not reusable. As such, a need exists for methods of producing concrete surfaces that are easier and less time consuming to produce than conventional methods. A method that includes the ability to reuse costly materials would be of particular benefit.

### SUMMARY

Objects and advantages of the disclosure will be set forth in part in the following description, or may be obvious from the description, or may be learned through the practice of the disclosure.

In accordance with one embodiment of the present disclosure, a method for making a concrete product is described. The method includes positioning a base material and one or more forms together such that the base material and the one or more forms define a volume. The base material and the one or more forms comprise polyester, polyvinyl chloride, polyurethane, polypropylene, polyethylene terephthalate or combinations thereof. The method further includes adding concrete in the volume defined by the base material and the one or more forms and allowing the concrete to dry to a sufficient hardness.

In another embodiment of the present disclosure, a method for making a concrete product is described. The method includes positioning a base material and one or more forms together such that the base material and the one or more forms define a volume. The base material and the one or more forms comprise polyester, polyvinyl chloride, polyurethane, polypropylene, polyethylene terephthalate or combinations thereof. An embossed vinyl film is added in the volume defined by the base material and the one or more forms, the embossed vinyl film having at least one raised feature on its surface. The method further includes adding concrete in the volume defined by the base material and the one or more forms and allowing the concrete to dry to a sufficient hardness such that the surface of the concrete is imprinted with at least one raised feature of the embossed vinyl film.

In yet another embodiment of the present disclosure, a kit for making a concrete surface is described. The kit includes a base material, one or more forms, embossed vinyl film, and concrete. The base material and the one or more forms comprise polyester, polyvinyl chloride, polyurethane, polypropylene, polyethylene terephthalate or combinations thereof.

Other features and aspects of the present disclosure are discussed in greater detail below.

### BRIEF DESCRIPTION OF THE DRAWINGS

A full and enabling disclosure, including the best mode thereof, directed to one of ordinary skill in the art, is set forth more particularly in the remainder of the specification, which makes reference to the appended figure in which:

FIG. 1 is a perspective view of one embodiment of a method that can be used in accordance with the present disclosure;

FIG. 2 is a perspective view of one embodiment of a method that can be used in accordance with the present disclosure;

FIG. 3 is a perspective view of one embodiment of a method that can be used in accordance with the present disclosure;

FIG. 4 is a perspective view of one embodiment of a method that can be used in accordance with the present disclosure; and

FIG. 5 is a perspective view of one embodiment of a concrete product that can be formed in accordance with the present disclosure

Repeat use of reference characters in the present specification and drawings is intended to represent same or analogous features or elements of the disclosure.

### DETAILED DESCRIPTION

Reference now will be made in detail to various embodiments of the disclosure, one or more examples of which are set forth below. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment, can be used on another embodiment to yield a still further embodiment. Thus, it is intended that the present disclosure covers such modifications and variations as come within the scope of the appended claims and their equivalents.

The present disclosure is generally directed to methods and products for making concrete surfaces by utilizing a base material and one or more forms that include polyester, polyvinyl chloride, polyurethane, polypropylene, polyethylene terephthalate or combinations thereof. It has been determined that the base materials and forms described herein can assist in the production of concrete surfaces in a fraction of the time and cost of concrete surfaces produced with conventional methods and products. In particular, the materials utilized to make the base materials and forms produce a smooth concrete surface without any required polishing.

For instance, conventional methods and products for forming concrete surfaces require the use of expensive base materials and forms as well as resource intensive polishing to grind a smooth surface into the face of the concrete surface, particularly in concrete countertop applications. Such polishing can require expensive finishing using diamond pads and the like. In addition, conventional techniques for adding interest to the surface of concrete surfaces are also very labor intensive and time consuming. Interest can refer to designs and/or other features that are inlaid or imprinted into the concrete surface.

The present disclosure describes methods and products that allow for the re-use of base materials and ease of creation for forms. Similarly, the present disclosure also describes methods and products that easily incorporate interest in the surfaces of concrete. Importantly, the methods and products of the present disclosure produce a concrete surface that does not require polishing to achieve a smooth surface. It has been determined that utilizing polyester can result in a smooth, glossy finish on the surface of concrete while other compounds such as polyethylene terephthalate can result in a smooth, matte finish.

As used herein, the term concrete refers to a mixture of cement, sand, rock (aggregate), water and small amounts of additives. In accordance with the present disclosure, concrete formulations can include a dry mixture of one type of hydraulic cement component and a lightweight aggregate component. The cement component can include one or more Portland cement constituents, preferably Portland cement type I. However, other types of white or gray Portland types I or III can also be used and are specifically contemplated by the present disclosure. Such cement components should meet United States Standards ASTM-C-150. Portland cement includes mainly tricalcium silicate and dicalcium silicate. The strength of the cementing agent is a function of the water-cement ratio. Therefore, strength will vary widely depending upon the amount of water used. To obtain maximum strength, the water-cement ratio should be kept as low as possible.

Formation of concrete is a process by which the voids between the particles of the coarse aggregate are filled by the fine aggregate, and the whole is cemented together by the binding action of the cement. Portland cement is a closely controlled chemical combination of calcium, silicon, aluminum, iron and small amounts of other compounds, to which gypsum is added in the final grinding process to regulate the setting time of the concrete. Some of the raw materials used to manufacture cement can include limestone, shells, and chalk or marl, combined with shale, clay, slate or blast furnace slag, silica sand, iron ore, or combinations thereof. Lime and silica can make up approximately about 85 percent of the mass.

Type I is a general purpose Portland cement suitable for all uses where the special properties of other types are not required. Type I can be used where cement or concrete is not subject to specific exposures, such as sulfate attack from soil or water, or to an objectionable temperature rise due to heat generated by hydration. Type I cement is used in many applications including concrete surface applications.

Type III is a high-early-strength cement. It is ground finer and reacts faster than Type I cement, so the early strength gains are greater. However, the ultimate strength is no higher than Type I.

In addition, other suitable component can be added to the mixture as would be appreciated by one of ordinary skill in the art. For example, pigments can be added for integral coloring.

Also, plasticizers can be utilized in concrete mixtures to reduce water content and strengthen the mixture. In certain embodiments, polycarboxylate is a preferred plasticizer for use with the present disclosure.

Upon mixing with a defined amount of water, the resulting mixture produces a cream, otherwise known as a fat layer, at the top which can be easily troweled smooth and produces a smooth finish without holes or other imperfections. Moreover, the mixture is easy to pour and spread and to vibrate without producing segregation.

While basic concrete can be made without the assistance of expensive machinery, certain types of concrete can only be made by ready-mixed concrete manufacturers that deliver such concrete ready to use in a ready mixed-concrete truck. There are many different concrete mix types that will differ depending on the application as well as the climate of installation. The present application is meant to encompass any suitable concrete mixture as would be known to one of ordinary skill in the art for utilizing the methods and products described herein.

In preferred embodiments, however, concrete from a bag mix is utilized. Bag mix concrete such as higher quality concrete mix utilizing finer sand and aggregates is generally preferred.

In addition to concrete mixes there are many supplies and tools needed for building a concrete surface, as would be known and recognized by one of ordinary skill in the art. Such supplies and tools can include, but are not limited to molds, casting tables, concrete mixers, reinforcing materials, coloring pigments, sealers, knockouts for specific applications, and the like. Again, it should be understood that the methods and products described herein contemplate the use or presence of suitable supplies and tools necessary for the formation of a concrete surface.

In particular, the methods and products described herein are particularly designed for use in connection with pre-cast concrete. Pre-cast concrete refers to concrete that is cast in a form and cured in a controlled environment, and then transported to the site where it is intended to be used.

It is believed that pre-cast concrete surfaces afford more control over the forming process. Materials are more easily utilized in a controlled environment without the fear of damaging finished cabinetry, flooring or other items where the concrete surface is to be located. It is also useful for concrete surfaces to be allowed ample curing time in a location secure from dust and debris.

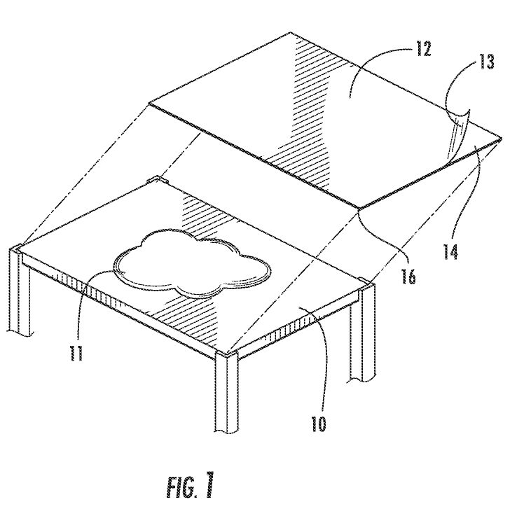

Referring to FIG. 1, products and methods for forming a concrete surface in accordance with certain embodiments of the present disclosure will be described in more detail. A method of the present disclosure includes providing a support and a base material onto which the concrete surface can be cast. The support can be formed from melamine, lexan, steel, aluminum, or any suitable support as would be known in the art. In certain embodiments, the support is flat and/or free of debris so as to limit the imperfections projected onto the base material and the concrete surface which is cast thereon. The purpose of the support is to provide a sufficient structural platform to support the weight of the countertop.

The base material can be formed of any suitable material that can take the shape of a flat, sheet-like structure. The base material includes polyester, polyvinyl chloride, polyurethane, polypropylene, polyethylene terephthalate or combinations thereof. The base material can have a thickness of from about 0.1 millimeters to about 100 millimeters, particularly from about 5 millimeters to about 70 millimeters, still more particularly from about 6 millimeters to about 15 millimeters. In certain preferred embodiments, the base material is thick enough so as to prevent the material from bending or creasing, such bending or creasing being capable of telegraphing into concrete and causing undesirable imperfections on the concrete surface. The base material can be of any suitable thickness as would be understood in the art.

In certain embodiments, the base material is formed from polyester, polyvinyl chloride, polyurethane, polypropylene, polyethylene terephthalate or combinations thereof. In certain embodiments, the base material is a sheet that is coated with polyester, polyvinyl chloride, polyurethane, polypropylene, polyethylene terephthalate or combinations thereof. For instance, the base material can be a sheet coated with the polyester. The coating applied to the base material can have a thickness of from about 0.01 to about 30 millimeters.

Referring again to FIG. 1, the base material 12 is placed over the support 10. In certain embodiments, the base material 12 is free of debris and air pockets so as to limit the imperfections projected onto the concrete surface which is cast thereon. A liquid can be poured onto the support 10 prior to the application of the base material 12 to assist in adhering the base material 12 to the support 10 and removing air pockets from the base material 12 that can cause imperfections in the concrete surface. For example, in certain embodiments, a liquid 11, such as water or liquid hand soap or the like can be poured onto the support prior to the application of the base material. In this manner, air pockets can be removed with a squeegee from the base material 12.

In certain embodiments, the base material 12 can have one or more protective film coatings 13 that can be peeled from the base material 12 to further assist in removing any debris that is located on the exterior 14 of the base material 12 that will come into contact with the concrete or the interior 16 of the base material 12 that contacts the support 10. The base material 12 can assist in eliminating the need for polishing once the concrete is removed from the base material 12.

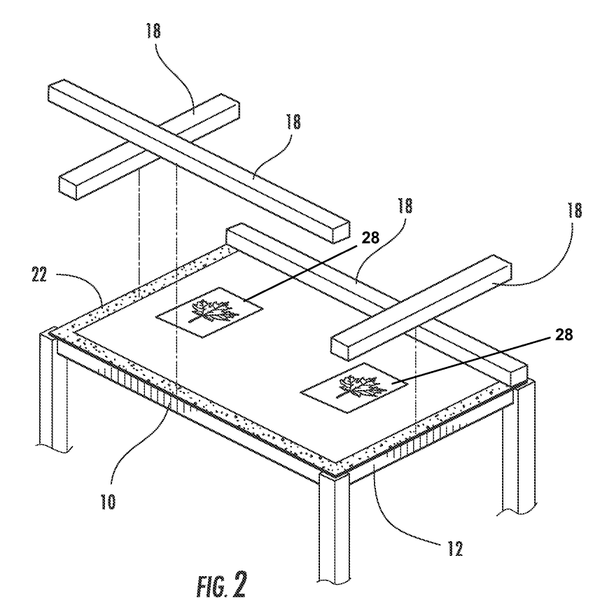

Turning to FIG. 2, one or more forms 18 can be assembled on the base material 12 to define a volume 20 into which concrete is poured. The forms 18 can be made of any suitable material to assist in forming the shape of the concrete. In addition, the forms 18 can be any suitable shape to assist in forming the shape of the concrete.

For instance, the forms can be generally rectangular in shape. The forms can assist in forming countertops, sinks, or other surfaces and both the base material and forms can be sized so as to correspond with standard shapes for countertops in kitchen, bath, or other applications. Furthermore, the forms can be utilized for commercial applications such as bartops, by way of example.

However, any other suitable shape can be utilized for the forms included rounded, oval, half-round barrel, beveled end, rectangular with rounded corners, sloped, ellipse, wave or the like. In addition, the forms can take shapes for sink molds and the like Indeed, the forms can be utilized to form modular knock-out shapes for a variety of products, including knife sets, wood carving boards, champagne buckets, or the like.

The forms can be made from polyester, polyvinyl chloride, polyurethane, polypropylene, polyethylene terephthalate or combinations thereof. For instance, the forms can be made formed a thermal formed plastic to any suitable shape and size.

In some embodiments, the forms are made from polystyrene, in particular, high-density or low-density expanded polystyrene. In such embodiments, the forms can be coated with polyester, polyvinyl chloride, polyurethane, polypropylene, polyethylene terephthalate or combinations thereof. The coating applied to the forms can have a thickness of from about 0.01 to about 10 millimeters.

The forms 18 can be assembled on the base materials 12 using any suitable method as would be known in the art so long as the forms 18 are held securely in place on the base material 12 and to each other when the concrete is added.

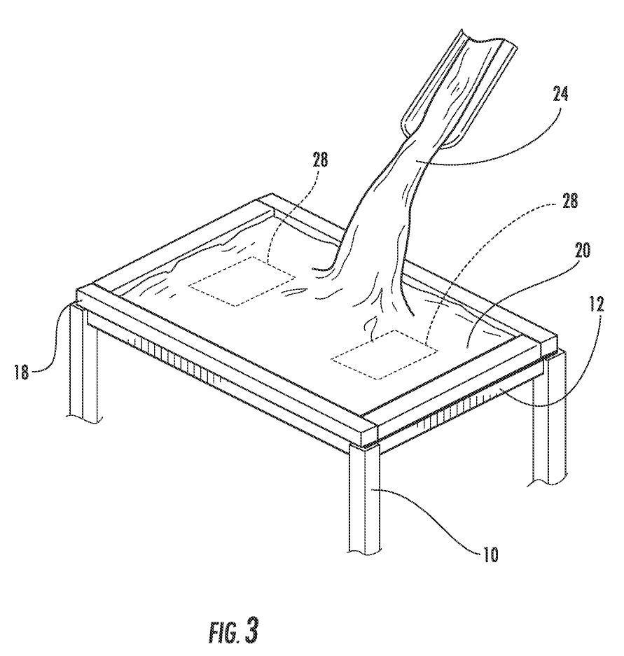

In certain embodiments, adhesive tape 22 is applied to the base material 12 in the locations that the forms 18 are to be placed onto the base material. The adhesive tape 22 is cut precisely so as to not be revealed on the exterior 14 of the base material once the forms 18 are applied. In particular, pressure sensitive double-sided adhesive tape can be utilized. In addition, the forms 18 can be secured to one another utilizing adhesive tape 22 (see FIG. 3). In certain embodiments, the tape can be coated with polyester, polyvinyl chloride, polyurethane, polypropylene, polyethylene terephthalate or combinations thereof. The coating applied to the tape can have a thickness of from about 0.01 to about 2 millimeters. Besides adhesive tape, however, it should be understood that any suitable method of assembling the forms and the base material can be utilized such as glue or the like.

Referring to FIG. 3, concrete 24 is added to the volume defined by the base material 12 and the forms 18. As described above, any suitable concrete as would be understood by one of ordinary skill in the art can be utilized in connection with the present disclosure. The concrete mixture 24 can be poured into the volume 20 and spread to a desired height, preferably not to exceed the height of the forms 18 that define the volume 20.

In certain embodiments, vibration is utilized to remove air bubbles from the concrete that can cause imperfections in the surface. Fine aggregates and sand tend to trap air bubbles, and a cement paste prevents the air from rising to escape. Vibration can assist in removing such air bubbles.

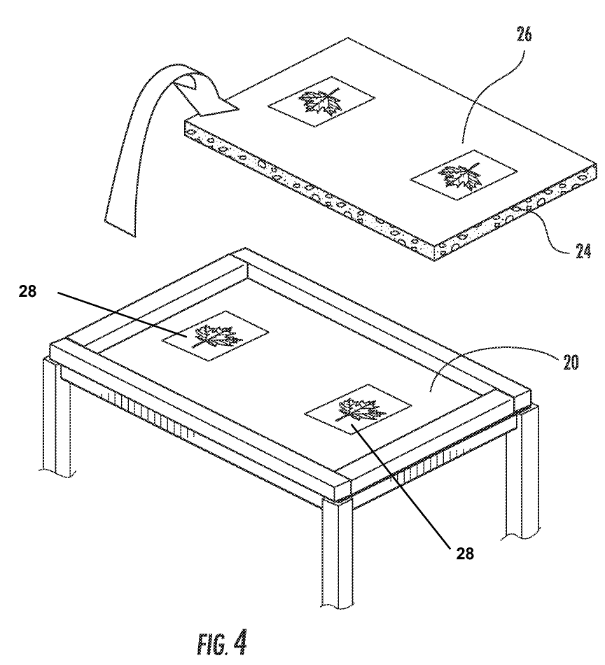

As shown in FIG. 4, the concrete 24 is allowed to dry to a sufficient hardness whereby it can be removed from the base material 12 and forms 18 and utilized for its intended application. The concrete surface 26 is smooth upon removal. Sufficient hardness refers to a hardness that allows the concrete to be removed from the forms without damaging the finished product because of cracking or chipping. In certain embodiments, heat or other environmental stimuli can be added to assist in drying the concrete.

Utilizing the methods of the present disclosure, there is no time consuming, labor intensive polishing required because the base materials 12 and forms 18 that contact the concrete produce a smooth concrete surface. Of additional advantage, once the base material 12 and forms 18 are removed, the support 10 can be reused which can greatly decrease the cost of production for the concrete surface.

Upon completion of the hardened concrete surface, one or more treatments can be added to the concrete surface 26. For instance, colors can be added to the surface either in addition to or exclusive of any colors that were previously added to the actual concrete mixture. Additionally, bare concrete can be porous and vulnerable to staining and chemical attack. Sealers as would be known in the art can be added to the concrete surface to aid in protecting the surface of the concrete.

In other exemplary embodiments of the present disclosure, interest can be added to concrete surfaces. Referring to FIG. 3, it has been determined that adding embossed film 28 in the volume defined by the base material and forms prior to the addition of concrete can assist in forming interest on the concrete surface. Once the concrete is added and allowed to harden, the embossed film 28 imprints microscopic shapes and/or patterns onto the surface of the concrete. Notably, the embossed vinyl film 28 has been found to imprint facets on the surface of the concrete that cause an iridescent effect on the surface of the concrete after the hardened concrete is removed from the base material, forms, and embossed film.

Any suitable embossed vinyl film can be utilized in accordance with the present disclosure. For instance SOLYX® embossed vinyl films can be used in accordance with the present disclosure. The embossed vinyl film can have any suitable shapes and patterns for transferring interest to the surface of the concrete.

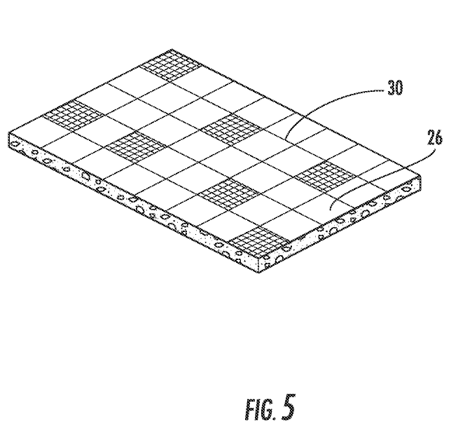

Referring to FIG. 5, a mosaic tile pattern 30 is depicted on the surface 26 of a finished concrete product. The hue can change on the surface of the concrete according to the angle from which the surface is viewed due to the iridescent property of the concrete. It should be appreciated that any suitable shape and/or pattern can be imprinted into the surface 26 of the concrete product formed in accordance with the present disclosure.

It should be understood that steps can be added or deleted from the method described herein that are consistent with the present disclosure. For instance, reinforcement material can be added to the volume defined so as to add structural rigidity to the concrete that is formed around the reinforcement material. In certain embodiments, such reinforcement material can be formed from metals, fibers, or the like. Additionally, those of ordinary skill in the art will appreciate that the production of concrete can be affected by numerous environmental factors that are not described in detail herein.

In the interests of brevity and conciseness, any ranges of values set forth in this specification are to be construed as written description support for claims reciting any sub-ranges having endpoints which are whole number values within the specified range in question. By way of a hypothetical illustrative example, a disclosure in this specification of a range of 1-5 shall be considered to support claims to any of the following sub-ranges: 1-4; 1-3; 1-2; 2-5; 2-4; 2-3; 3-5; 3-4; and 4-5.

These and other modifications and variations to the present disclosure can be practiced by those of ordinary skill in the art, without departing from the spirit and scope of the present disclosure, which is more particularly set forth in the appended claims. In addition, it should be understood that aspects of the various embodiments can be interchanged both in whole or in part. Furthermore, those of ordinary skill in the art will appreciate that the foregoing description is by way of example only, and is not intended to limit the disclosure so further described in such appended claims.

What is claimed:

1. A method of making a concrete product comprising:
positioning a base material and one or more forms together such that the base material and the one or more forms define a volume, the base material and the one or more forms comprising polyester, polyvinyl chloride, polyurethane, polypropylene, polyethylene terephthalate or combinations thereof;
adding concrete in the volume defined by the base material and the one or more forms; and
allowing the concrete to dry to a sufficient hardness.

2. A method as in claim 1, further comprising removing the concrete from the volume defined by the base material and the one or more forms.

3. A method as in claim 1, wherein the polyester, polyvinyl chloride, polyurethane, polypropylene, polyethylene terephthalate or combinations thereof comprises a layer on the base material.

4. A method as in claim 3, wherein the layer has a thickness of from about 0.01 millimeters to about 10 millimeters.

5. A method as in claim 1, wherein the polyester, polyvinyl chloride, polyurethane, polypropylene, polyethylene terephthalate or combinations thereof comprises a layer on the one or more forms.

6. A method as in claim 5, wherein the layer has a thickness of from about 0.01 millimeters to about 10 millimeters.

7. A method as in claim 1, wherein the forms comprise polystyrene.

8. A method as in claim 1, wherein at least one form has a generally rectangular shape.

9. A method as in claim 1, wherein the base material is generally flat.

10. A method as in claim 1, wherein the base material and the one or more forms are positioned on a generally flat surface comprising melamine, lexan, steel, aluminum, or combinations thereof.

11. A method as in claim 1, wherein at least one form has a generally curved shape.

12. A method as in claim 1, wherein the base material and the one or more forms comprise polyester.

13. A method as in claim 1, further comprising adding an embossed vinyl film in the volume defined by the base material and the one or more forms prior to adding the concrete.

14. A method as in claim 1, further comprising making the hardened concrete into a countertop.

15. A method as in claim 1, further comprising making the hardened concrete into a sink.

16. A method as in claim 1, wherein the base material and forms are positioned together with pressure sensitive adhesive.

17. A method of making a concrete product comprising:
positioning a base material and one or more forms together such that the base material and the one or more forms define a volume, the base material and the one or more forms comprising polyester, polyvinyl chloride, polyurethane, polypropylene, polyethylene terephthalate or combinations thereof;
adding an embossed vinyl film in the volume defined by the base material and the one or more forms, the embossed vinyl film having at least one raised feature on its surface;
adding concrete in the volume defined by the base material and the one or more forms; and
allowing the concrete to dry to a sufficient hardness such that the surface of the concrete is imprinted with at least one raised feature of the embossed vinyl film.

18. A method as in claim 17, further comprising removing the concrete from the volume defined by the base material and the one or more forms.

19. A method as in claim 17, wherein the base material and the one or more forms comprise polyester.

20. A method as in claim 17, wherein the surface of the concrete is imprinted with facets.

21. A method as in claim 17, wherein at least a portion of the surface of the concrete is iridescent.

22. A method as in claim 17, further comprising adding one or more treatments to the surface of the hardened concrete.

23. A method as in claim 17, wherein the surface of the concrete is imprinted with a tile pattern.

24. A kit for making a concrete product comprising:
a base material and one or more forms comprising polyester, polyvinyl chloride, polyurethane, polypropylene, polyethylene terephthalate or combinations thereof;
embossed vinyl film; and
concrete.

25. A kit as in claim 24, wherein the base material and the one or more forms comprise polyester.
